(19) United States
(12) Patent Application Publication
(10) Pub. No.: US 2026/0181363 A1
(43) Pub. Date: Jun. 25, 2026

(54) SIGNAL SENSING METHODS AND APPARATUSES, CORE NETWORK ELEMENT, ELECTRONIC DEVICES, AND STORAGE MEDIUMS

(71) Applicant: Beijing Xiaomi Mobile Software Co., Ltd., Beijing (CN)

(72) Inventors: Jianning LIU, Beijing (CN); Yang SHEN, Beijing (CN); Wei LU, Beijing (CN); Haoran LIANG, Beijing (CN)

(21) Appl. No.: 19/125,456

(22) PCT Filed: Oct. 31, 2022
(86) PCT No.: PCT/CN2022/128825

§ 371 Date: Apr. 29, 2025

(51) Int. Cl. H04W 4/50

(52) U.S. Cl. CPC H04W 4/50

(57) ABSTRACT

A signal sensing method is performed by a request processing end. The method includes: receiving a sensing service request; and generating a sensing signal configuration according to the sensing service request, wherein the sensing signal configuration is configured for enabling a first sensing node to transmit or receive a sensing signal.

### CROSS-REFERENCE TO RELATED APPLICATIONS

This disclosure is a U.S. National phase application of International Application No. PCT/CN2022/128825, filed on Oct. 31, 2022, the entire content of which is incorporated herein by reference.

### TECHNICAL FILED

This disclosure relates to the field of sensing technologies, and in particular, to signal sensing methods, devices, a core network element, electronic devices, and storage mediums.

### BACKGROUND

Wireless sensing refers to the process by which a sensing node transmits and receives sensing signals, and processes and analyzes the received sensing signals to obtain the sensing information therein. In related technologies, sensing signals are uniformly and openly transmitted outward according to fixed signal parameters. This will lead to the problem of poor security of the sensing information, as some other nodes may also be able to obtain the sensing signals and then the sensing information therein.

### SUMMARY

According to a first aspect of the embodiments of this disclosure, a signal sensing method is provided, which is applied to a request processing end. The method includes: receiving a sensing service request; and generating a sensing signal configuration according to the sensing service request, where the sensing signal configuration is configured for enabling a first sensing node to transmit or receive a sensing signal.

According to a second aspect of the embodiments of this disclosure, a signal sensing method is provided, which is applied to a request initiating end. The method includes: sending a sensing service request to a request processing end, where the sensing service request is configured for requesting generation of a sensing signal configuration, and the sensing signal configuration is configured for enabling a first sensing node to transmit or receive a sensing signal.

According to a third aspect of the embodiments of this disclosure, a signal sensing method is provided, which is applied to a sensing node. The method includes: receiving a sensing signal configuration, where the sensing signal configuration is generated by a request processing end in response to a sensing service request from a request initiating end; and transmitting or receiving a sensing signal according to the sensing signal configuration.

According to a fourth aspect of the embodiments of this disclosure, a core network element is provided, including: a first processor; and a first memory for storing instructions executable by the first processor. The first processor, when executing the instructions, acts as a request processing end to execute the signal sensing method according to the first aspect.

According to a fifth aspect of the embodiments of this disclosure, an electronic device is provided, including: a second processor; and a second memory for storing instructions executable by the second processor. The second processor, when executing the instructions, acts as a request initiating end to execute the signal sensing method according to the second aspect.

According to a sixth aspect of the embodiments of this disclosure, an electronic device is provided, including: a third processor; and a third memory for storing instructions executable by the third processor. The third processor, when executing the instructions, acts as a sensing node to execute the signal sensing method according to the third aspect.

According to a seventh aspect of the embodiments of this disclosure, a non-transitory storage medium is provided, on which a computer program is stored. When the computer program is executed by a processor, the signal sensing method according to the first aspect is implemented.

According to an eighth aspect of the embodiments of this disclosure, a non-transitory storage medium is provided, on which a computer program is stored. When the computer program is executed by a processor, the signal sensing method according to the second aspect is implemented.

According to a ninth aspect of the embodiments of this disclosure, a non-transitory storage medium is provided, on which a computer program is stored. When the computer program is executed by a processor, the signal sensing method according to the third aspect is implemented.

According to a tenth aspect of the embodiments of this disclosure, a signal sensing system is provided, including a request initiating end and a request processing end, where the request initiating end is configured to execute the signal sensing method according to the second aspect; and the request processing end is configured to execute the signal sensing method according to the first aspect.

It should be understood that the above general description and the following detailed description are exemplary and explanatory only, and do not limit this disclosure.

### BRIEF DESCRIPTION OF THE DRAWINGS

The drawings herein are incorporated into the specification and form a part of the specification, showing embodiments that conform to this disclosure, and are used together with the specification to explain the principles of this disclosure.

FIG. 1 shows a schematic diagram of a signal sensing system applicable to a signal sensing method provided by the embodiments of this disclosure.

FIG. 2 shows a flowchart of a signal sensing method in an exemplary embodiment.

FIG. 3 shows a flowchart of a signal sensing method in an exemplary embodiment.

FIG. 4 shows a flowchart of a signal sensing method in an exemplary embodiment.

FIG. 5 shows a flowchart of a signal sensing method in an application scenario of sensing mode A in an exemplary embodiment.

FIG. 6 shows a flowchart of a signal sensing method in another application scenario of sensing mode A in an exemplary embodiment.

FIG. 7 shows a flowchart of a signal sensing method in an application scenario of sensing mode B in an exemplary embodiment.

FIG. 8 shows a flowchart of a signal sensing method in another application scenario of sensing mode B in an exemplary embodiment.

FIG. 9 shows a flowchart of a signal sensing method in an application scenario of sensing mode D in an exemplary embodiment.

FIG. 10 shows a flowchart of a signal sensing method in an exemplary embodiment.

FIG. 11 shows a flowchart of a signal sensing method in an exemplary embodiment.

FIG. 12 shows a block diagram of a signal sensing device in an exemplary embodiment.

FIG. 13 shows a block diagram of a signal sensing device in an exemplary embodiment.

FIG. 14 shows a block diagram of a signal sensing device in an exemplary embodiment.

FIG. 15 shows a block diagram of a core network element in an exemplary embodiment.

FIG. 16 shows a block diagram of an electronic device in an exemplary embodiment.

FIG. 17 shows a block diagram of an electronic device in an exemplary embodiment.

### DETAILED DESCRIPTION

Here, exemplary embodiments will be described in detail, and the examples are shown in the drawings. When the following description refers to the drawings, unless otherwise indicated, the same numbers in different drawings represent the same or similar elements. The implementation manners described in the following exemplary embodiments do not represent all implementation manners consistent with this disclosure. On the contrary, they are only examples of devices and methods consistent with some aspects of this disclosure as detailed in the appended claims.

It should be noted that all actions of acquiring signals, information, or data in this disclosure are carried out under the premise of complying with the corresponding data protection regulations and policies of the country where it is located and with the authorization given by the owner of the corresponding device.

In the description of this disclosure, terms such as “first” and “second” are used to distinguish similar objects, and do not need to be understood as having a specific order or sequence. In addition, unless stated otherwise, in the description with reference to the drawings, the same label in different drawings represents the same element.

In the description of this disclosure, unless otherwise stated, “a plurality of” means two or more, and other quantifiers are similar; “at least one (item) of the following . . . ”, “one (item) or a plurality of (items)” or similar expressions refer to any combination of these items, including any combination of a single item or multiple items. For example, one (item) or a plurality of (items) of a, b, or c can represent: a, b, c, a combination of a and b, a combination of a and c, a combination of b and c, or a combination of a, b, and c, where a, b, c can each be singular or plural; “and/or” is a description of the relationship between associated objects, indicating that there can be three relationships. For example, A and/or B can represent that: A exists alone, A and B exist simultaneously, and B exists alone. Here, A and B can be singular or plural.

In the embodiments of this disclosure, although operations are described in a specific order in the drawings, it should not be understood as requiring these operations to be executed in the specific order shown or in a serial order, nor is it required to execute all the shown operations to obtain the desired results. In a specific environment, multitasking and parallel processing may be beneficial. In addition, it is also beneficial to send a plurality of pieces of information through the same message.

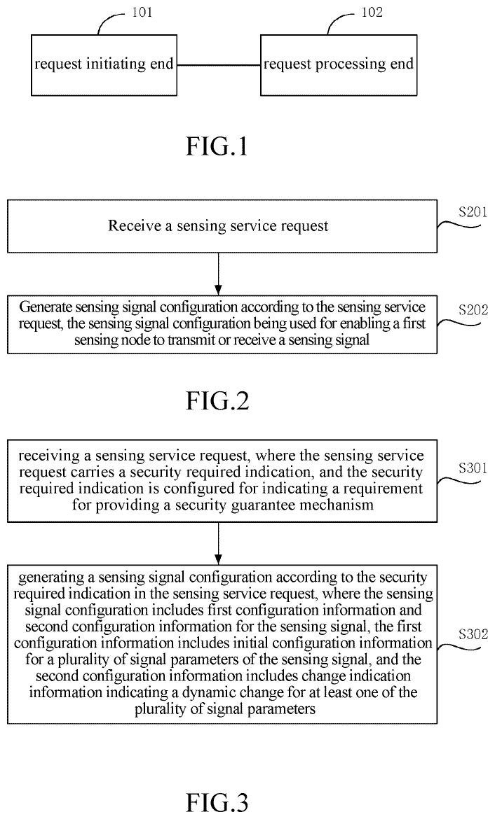

To solve the problem of poor security of sensing information in related technologies, the embodiments of this disclosure provide corresponding signal sensing methods. FIG. 1 is a schematic diagram of a signal sensing system applicable to a signal sensing method provided by the embodiments of this disclosure. The signal sensing system includes: a request initiating end 101 and a request processing end 102. The request initiating end 101 is configured to send a sensing service request to the request processing end 102, and the request processing end 102 is configured to receive the sensing service request sent by the request initiating end 101 and process this sensing service request. Specifically, the request processing end 102 generates a sensing signal configuration according to this sensing service request, so that a sensing node performing the sensing service can transmit or receive sensing signals based on this sensing signal configuration.

In an optional embodiment, the request initiating end 101 can be any one of the following:
a terminal; or
a third-party server.

In an optional embodiment, the request processing end 102 can be any one of the following:
a terminal;
a target network element in a core network; or
an access network device and a target network element in a core network.

It should be noted that the embodiments of this disclosure can be applied to various different sensing modes, and each sensing mode corresponds to a different application scenario of the signal sensing method of the embodiments of this disclosure. In different sensing modes, the request initiating end 101 and the request processing end 102 in the above-mentioned signal sensing system are different.

For example, in a sensing mode indicating sensing between terminals, in the above-mentioned signal sensing system, the request initiating end 101 is a terminal, and the request processing end 102 is another terminal.

For example, in a sensing mode indicating sensing between a terminal and an access network device, in the above-mentioned signal sensing system, the request initiating end 101 is a terminal, and the request processing end 102 is a target network element in a core network, or the request processing end 102 is a combination of an access network device and a target network element in the core network.

For example, in a sensing mode indicating sensing between access network devices, in the above-mentioned signal sensing system, the request initiating end 101 is a third-party server, and the request processing end 102 is a target network element in the core network, or the request processing end 102 is a combination of an access network device and a target network element in the core network.

In this disclosure, the terminal or access network device that performs the sensing service is called a sensing node.

Therefore, the sensing node in this disclosure can be any one of the following:
a terminal; or
an access network device.

It can be understood that the number of sensing nodes performing the sensing service can be one, that is, the same sensing node both transmits and receives sensing signals to achieve sensing. Alternatively, there can be a plurality of sensing nodes, that is, among the plurality of sensing nodes, one sensing node transmits sensing signals, and the other sensing nodes receive sensing signals to achieve sensing.

Therefore, the sensing nodes performing the sensing service can include a first sensing node and a second sensing node. The first sensing node and the second sensing node may be the same node or different nodes.

FIG. 2 shows a flowchart of a signal sensing method in an exemplary embodiment. The signal sensing method is applied to a request processing end. As shown in FIG. 2, the method includes the following steps.

S201, receiving a sensing service request.

S202, generating a sensing signal configuration according to the sensing service request. The sensing signal configuration is configured for enabling a first sensing node to transmit or receive a sensing signal.

In the above process, a sensing service request is initiated and a sensing signal configuration is generated based on this sensing service request, causing the first sensing node to transmit or receive the sensing signal based on this sensing signal configuration. In this way, other nodes cannot correctly receive and process the sensing signal because they cannot obtain the sensing signal configuration, and thus cannot obtain the sensing information therein. This realizes the security protection of the sensing information.

Specifically, in response to the generation of the sensing signal configuration, the first sensing node can acquire this sensing signal configuration in various ways. For example, when the first sensing node is part of the request processing end, the first sensing node can directly acquire the sensing signal configuration as it is generated. When the first sensing node is another terminal or device different from the request processing end, the first sensing node can acquire the sensing signal configuration through signaling interaction and other means.

In an optional embodiment, the sensing service request carries a security required indication, and the security required indication is configured for indicating whether a security guarantee mechanism is required to be provided.

In step S202, if the security required indication indicates a requirement for providing a security guarantee mechanism, a sensing signal configuration is generated according to the security required indication. The sensing signal configuration includes first configuration information and second configuration information for the sensing signal. The first configuration information includes initial configuration information for a plurality of signal parameters of the sensing signal, and the second configuration information includes change indication information indicating a dynamic change for at least one of the plurality of signal parameters.

Therefore, when a security guarantee mechanism is required to be provided, the request processing end configures a dynamic sensing signal parameter for the first sensing node, so that the sensing signal transmitted or received by the first sensing node changes dynamically. The sensing signal is based on the initial configuration information in the first configuration information and changes dynamically according to the change indication information in the second configuration information.

As an example, the plurality of signal parameters of the above-mentioned sensing signal can include at least one of the following: initial time, a period, and a frequency domain for transmitting the sensing signal.

In step S202, if the security required indication indicates that no security guarantee mechanism is required to be provided, a sensing signal configuration is generated according to the security required indication. The sensing signal configuration includes first configuration information for the sensing signal, and the first configuration information includes configuration information for a plurality of signal parameters of the sensing signal.

Therefore, when a security guarantee mechanism is not required to provided, the request processing end configures a static sensing signal parameter for the first sensing node, so that the sensing signal transmitted or received by the first sensing node remain static to save power consumption.

As an example, the plurality of signal parameters of the above-mentioned sensing signal can include at least one of the following: initial time, a period, and a frequency domain for transmitting the sensing signal.

FIG. 3 shows a flowchart of a signal sensing method in an exemplary embodiment. The signal sensing method is applied to a request processing end. As shown in FIG. 3, the method includes the following steps.

S301, receiving a sensing service request. The sensing service request carries a security required indication, and the security required indication is configured for indicating a requirement for providing a security guarantee mechanism.

S302, generating a sensing signal configuration according to the security required indication in the sensing service request. The sensing signal configuration includes first configuration information and second configuration information for the sensing signal. The first configuration information includes initial configuration information for a plurality of signal parameters of the sensing signal, and the second configuration information includes change indication information indicating a dynamic change for at least one of the plurality of signal parameters.

In the above process, when a security guarantee mechanism is required to be provided, the request processing end configures a dynamic sensing signal parameter for the first sensing node, so that the sensing signal transmitted or received by the first sensing node changes dynamically. The sensing signal is based on the initial configuration information in the first configuration information and changes dynamically according to the change indication information in the second configuration information. When the sensing signal changes dynamically, it ensures that only the sensing nodes that obtain the sensing signal configuration can correctly receive and process the sensing signals, which provides stronger protection for the security of the sensing information.

As an example, the plurality of signal parameters of the above-mentioned sensing signal can include at least one of the following: initial time, a period, and a frequency domain for transmitting the sensing signal.

In an optional embodiment, the second configuration information includes first change indication information indicating a dynamic change for the period of the sensing signal, and/or second change indication information indicating a dynamic change for the frequency domain of the sensing signal.

As an example, in the above-mentioned first change indication information, the periods corresponding to other times after the initial time for transmitting the sensing signal can be listed to indicate the dynamic change of the period. Alternatively, the first change indication information is configured for indicating a change rule of the dynamic change of the period, so that the sensing node can calculate the periods corresponding to other times after the initial time for transmitting the sensing signal by itself based on the change rule indicated by the first change indication information.

As an example, in the above-mentioned second change indication information, the frequency domains corresponding to other times after the initial time for transmitting the sensing signal can be listed to indicate the dynamic change of the frequency domain. Alternatively, the second change indication information is configured for indicating a change rule of the dynamic change of the frequency domain, so that the sensing node can calculate the frequency domains corresponding to other times after the initial time for transmitting the sensing signal by itself based on the change rule indicated by the second change indication information.

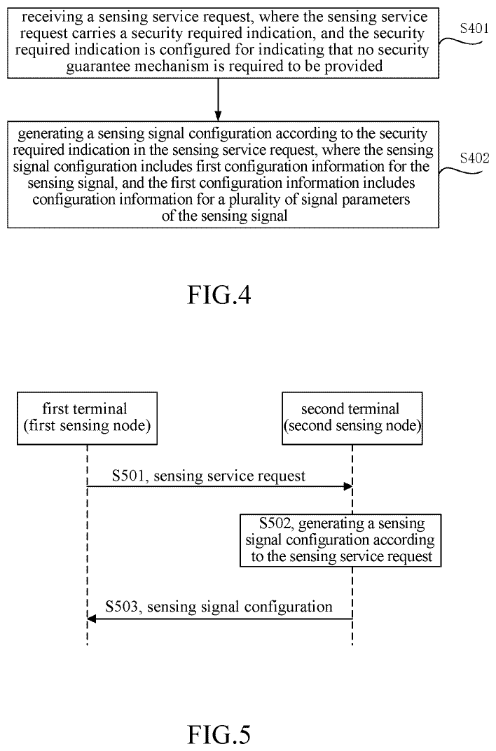

FIG. 4 shows a flowchart of a signal sensing method in an exemplary embodiment. The signal sensing method is applied to a request processing end. As shown in FIG. 4, the method includes the following steps.

S401, receiving a sensing service request. The sensing service request carries a security required indication, and the security required indication is configured for indicating that no security guarantee mechanism is required to be provided.

S402, generating a sensing signal configuration according to the security required indication in the sensing service request. The sensing signal configuration includes first configuration information for the sensing signal, and the first configuration information includes configuration information for a plurality of signal parameters for the sensing signal.

In the above process, when a security guarantee mechanism is not required to be provided, the request processing end configures static sensing signal parameters for the first sensing node, so that the sensing signal transmitted or received by the first sensing node remain static to save power consumption.

As an example, the plurality of signal parameters of the above-mentioned sensing signal can include at least one of the following: initial time, a period, and a frequency domain for transmitting the sensing signal.

It can be understood that in some embodiments, the request processing end includes a target network element in the core network, and the target network element can generate a sensing signal configuration according to the sensing service request.

In other embodiments, the request processing end includes an access network device and a target network element in the core network. The target network element sends, according to the sensing service request, indication information to the access network device as a sensing node, and the access network device as a sensing node generates, according to the indication information, a sensing signal configuration by itself.

Therefore, in this disclosure, the generation of the sensing signal configuration can be executed by the target network element or by the access network device as a sensing node.

In some embodiments, the sensing service request carries a sensing mode.

In some sensing modes, the request processing end includes a target network element in the core network. The target network element receives the sensing service request and determines the first sensing node according to the sensing mode in the sensing service request.

For example, when the sensing mode indicates sensing between terminals, the terminal that sends the sensing service request is determined as the first sensing node.

For example, when the sensing mode indicates sensing between a terminal and an access network device, a target access network device that performs the sensing service is selected from the access network devices as the first sensing node.

Specifically, the target access network device that performs the sensing service in the access network devices can be determined as the first sensing node. The target access network device here can be the same as or different from the access network device that receives the sensing service request.

For example, when the sensing mode indicates sensing between access network devices, a first target access network device and a second target access network device that perform the sensing service are selected from the access network devices and used as the first sensing node and the second sensing node respectively.

Specifically, the first target access network device and the second target access network device that perform the sensing service in the access network devices can be determined as the first sensing node and the second sensing node respectively.

The sensing mode indicating sensing between a terminal and an access network device can be further divided into:
a sensing mode indicating that the terminal transmits a sensing signal and the access network device receives the sensing signal, and a sensing mode indicating that the access network device transmits a sensing signal and the terminal receives the sensing signal.

In the specific implementation of this solution, the request initiating end can determine the specific sensing mode and security required indication according to the indication of its service layer, and generate a corresponding sensing service request according to the sensing mode and security required indication. For example, if the request initiating end is a terminal, and the service layer of the terminal indicates that the current sensing service requires sensing performed with another terminal and the current sensing service requires a corresponding security guarantee mechanism to be provided, the terminal generates a corresponding sensing service request according to the indication of the service layer.

It should be noted that the target network element in this disclosure is a network element used to undertake a Sensing Function (SF). Specifically, a new network element can be added to the core network as the target network element, or an existing network element in the current core network can be used as the target network element.

For the convenience of description, the following lists several sensing modes applicable to the signal sensing method of the embodiments of this disclosure:
Sensing mode A indicating sensing between terminals;
Sensing mode B indicating that a terminal transmits a sensing signal and an access network device receives the sensing signal;
Sensing mode C indicating that an access network device transmits a sensing signal and a terminal receives the sensing signal; and
Sensing mode D indicating sensing between access network devices.

FIG. 5 shows a flowchart of a signal sensing method in an application scenario of sensing mode A in an exemplary embodiment. In this application scenario, sensing is performed between terminals, with device-to-device communication between the terminals. One terminal is used to initiate a sensing service request to another terminal, and the other terminal is used to receive the sensing service request, generate a sensing signal configuration according to the sensing service request, and send the sensing signal configuration to the aforementioned terminal.

Furthermore, one terminal is called the first terminal, and the other terminal is called the second terminal. It should be understood that the second terminal can be one or more, that is, the first terminal can perform sensing with a plurality of second terminals. Similarly, the first terminal can also be one or more, that is, the second terminal can also perform sensing with a plurality of first terminals.

Referring to FIG. 5, the specific process of the signal sensing method is as follows.

S501, the first terminal sends a sensing service request to the second terminal.

S502, the second terminal generates a sensing signal configuration according to the sensing service request.

S503, the second terminal sends the sensing signal configuration to the first terminal.

Through the above process, both the first terminal and the second terminal obtain the same sensing signal configuration, so that sensing can be achieved between the first terminal and the second terminal. Other nodes cannot obtain the sensing signal configuration, so they cannot correctly receive and process the sensing signals, and thus cannot obtain the sensing information therein.

As a specific embodiment, there is a short-distance connection between the first terminal and the second terminal. The service layer of the first terminal indicates that the current sensing service requires sensing performed with the second terminal, and does not require a security guarantee mechanism to be provided. Then the first terminal determines the corresponding sensing mode and security required indication according to the indication of the service layer, generates a corresponding sensing service request according to the sensing mode and security required indication, and initiates the sensing service request to the second terminal.

The second terminal generates a sensing signal configuration according to the security required indication in the sensing service request, determines the first terminal that sends the sensing service request as the first sensing node and itself as the second sensing node according to the sensing mode, and then sends the sensing signal configuration to the first terminal which serves as the first sensing node.

The specific process of generating the sensing signal configuration refers to the previous description and will not be repeated here.

In the above example, the first terminal serves as the first sensing node, and the second terminal serves as the second sensing node. At the same time, the first terminal also serves as the request initiating end, and the second terminal also serves as the request processing end.

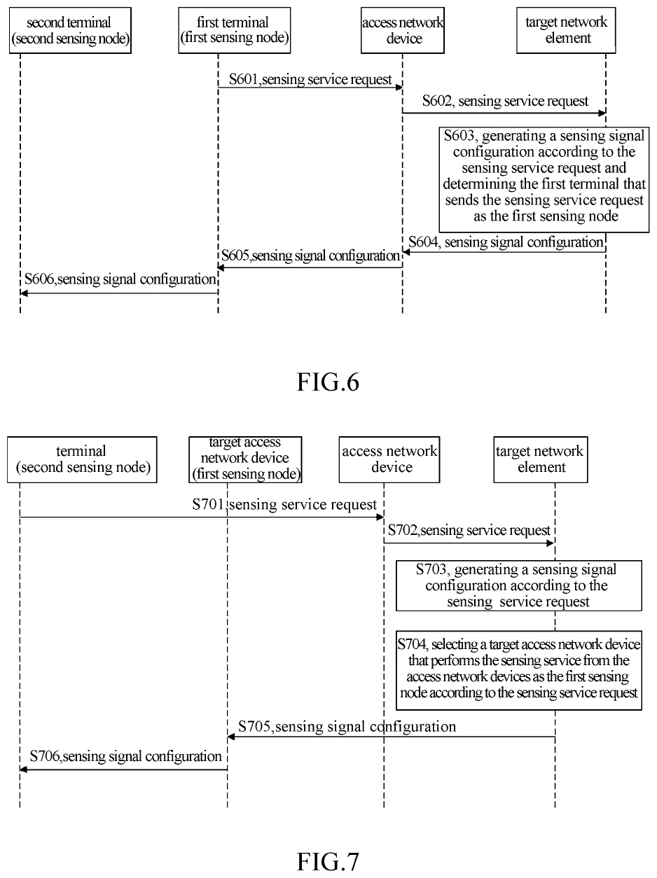

FIG. 6 shows a flowchart of a signal sensing method in another application scenario of sensing mode A in an exemplary embodiment. In this application scenario, sensing is performed between terminals, and the terminals are not in device-to-device communication. One terminal is used to initiate a sensing service request to the network, and the target network element in the core network is used to receive the sensing service request, generate a sensing signal configuration according to the sensing service request, and send the sensing signal configuration to the aforementioned terminal.

Furthermore, one terminal is called the first terminal, and the other terminal is called the second terminal. It should be understood that the second terminal can be one or more, that is, the first terminal can perform sensing with a plurality of second terminals. Similarly, the first terminal can also be one or more, that is, the second terminal can also perform sensing with a plurality of first terminals.

Referring to FIG. 6, the specific process of the signal sensing method is as follows.

S601, the first terminal sends a sensing service request to the access network device.

S602, the access network device sends the sensing service request to the target network element in the core network.

Exemplarily, the access network device can send the sensing service request directly to the target network element in the core network. Alternatively, the access network device can send the sensing service request to the access and mobility management function (AMF) network element in the core network, and then the AMF network element sends the sensing service request to the target network element.

S603, the target network element generates a sensing signal configuration according to the sensing service request and determines the first terminal that sends the sensing service request as the first sensing node.

The specific process of generating the sensing signal configuration refers to the previous description and will not be repeated here.

S604, the target network element sends the sensing signal configuration to the access network device and instructs the access network device to send the sensing signal configuration to the first terminal which serves as the first sensing node.

S605, the access network device sends the sensing signal configuration to the first terminal which serves as the first sensing node.

S606, the first terminal as the first sensing node sends the sensing signal configuration to the second terminal which serves as the second sensing node.

Through the above process, both the first terminal and the second terminal obtain the same sensing signal configuration, so that sensing can be achieved between the first terminal and the second terminal. Other nodes cannot obtain the sensing signal configuration, so they cannot correctly receive and process the sensing signals, and thus cannot obtain the sensing information therein.

As a specific embodiment, there is no short-distance connection between the first terminal and the second terminal. The service layer of the first terminal indicates that the current sensing service requires sensing performed with the second terminal, and the does not require a security guarantee mechanism to be provided. Then the first terminal determines the corresponding sensing mode and security required indication, generates a corresponding sensing service request according to the sensing mode and security required indication, and initiates the sensing service request to the network. After that, the first terminal receives the sensing signal configuration and sends the sensing signal configuration to the second terminal.

As another specific embodiment, there is no short-distance connection between the first terminal and the second terminal. The service layer of the first terminal indicates that the current sensing service requires sensing performed with another terminal, but does not indicate the specific terminal for sensing, and the service layer also indicates that the current sensing service does not require a security guarantee mechanism to be provided. Then the first terminal determines the corresponding sensing mode and security required indication, generates a corresponding sensing service request according to the sensing mode and security required indication, and initiates the sensing service request to the network.

In step S603, the target network element determines the first terminal that sends the sensing service request as the first sensing node according to the sensing mode in the sensing service request, and also needs to select a second sensing node that performs the sensing service, that is, determine the second sensing node that performs sensing with the first sensing node. For example, the target network element acquires the sensing capabilities of each terminal and the network location of each terminal, and selects a terminal that is under the same access network device as the first sensing node and possesses sensing capabilities as the second sensing node.

It is assumed that the target network element determines the second terminal as the second sensing node. Then the target network element sends the sensing signal configuration and the identification information of the second terminal to the access network device. The access network device sends the sensing signal configuration and the identification information of the second terminal to the first terminal. The first terminal sends, according to the identification information of the second terminal, the sensing signal configuration to the second terminal.

In the above example, the first terminal serves as the first sensing node, and the second terminal serves as the second sensing node. At the same time, the first terminal also serves as the request initiating end, and the target network element in the core network serves as the request processing end.

In some embodiments, the sensing between terminals includes self-sensing performed by a terminal on its own, meaning that the terminal both transmits sensing signals and receives the sensing signals it has transmitted to achieve sensing. In such cases, after the terminal as the first sensing node receives the sensing signal configuration, it does not send the sensing signal configuration to other terminals.

FIG. 7 shows a flowchart of a signal sensing method in an application scenario of sensing mode B in an exemplary embodiment. In this application scenario, sensing is performed between a terminal and an access network device, and the terminal transmits sensing signals, and the access network device receives the sensing signals transmitted by the terminal to achieve sensing. The terminal is used to initiate a sensing service request to the network, and the target network element in the core network serves as the request processing end, which is used to receive the sensing service request, generate a sensing signal configuration according to the sensing service request, and send the sensing signal configuration to the aforementioned terminal.

Furthermore, referring to FIG. 7, the specific process of the signal sensing method is as follows.

S701, the terminal sends a sensing service request to the access network device.

S702, the access network device sends the sensing service request to the target network element in the core network.

Exemplarily, the access network device can send the sensing service request directly to the target network element in the core network. Alternatively, the access network device sends the sensing service request to the AMF network element in the core network, and then the AMF network element sends the sensing service request to the target network element.

S703, the target network element generates a sensing signal configuration according to the sensing service request.

Exemplarily, if the sensing service request carries a security required indication, the target network element generates a sensing signal configuration according to the security required indication in the sensing service request. The specific process of generating the sensing signal configuration refers to the previous description and will not be repeated here.

S704, the target network element selects a target access network device that performs the sensing service from the access network devices as the first sensing node according to the sensing service request.

Exemplarily, if the sensing service request carries a sensing mode, the target network element selects a target access network device that performs the sensing service from the access network devices as the first sensing node according to the sensing mode in the sensing service request, and also determines the terminal that sends the sensing service request as the second sensing node.

For example, in this application scenario, a target access network device is selected, according to the sensing mode, from the access network devices that can provide the service of receiving sensing signals. Specifically, the selection can also be combined with the relevant policy information stored in the network. The target access network device may or may not be the same as the access network device in the previous step S702.

S705, the target network element sends the sensing signal configuration to the target access network device which serves as the first sensing node.

S706, the target access network device as the first sensing node sends the sensing signal configuration to the terminal as the second sensing node.

Through the above process, both the terminal and the target access network device that perform the sensing service obtain the same sensing signal configuration, so that sensing can be achieved between the terminal and the target access network device. Other nodes cannot obtain the sensing signal configuration, so they cannot correctly receive and process the sensing signals, and thus cannot obtain the sensing information therein.

In the above example, the target access network device serves as the first sensing node, and the terminal serves as the second sensing node. At the same time, the terminal also serves as the request initiating end, and the target network element in the core network serves as the request processing end.

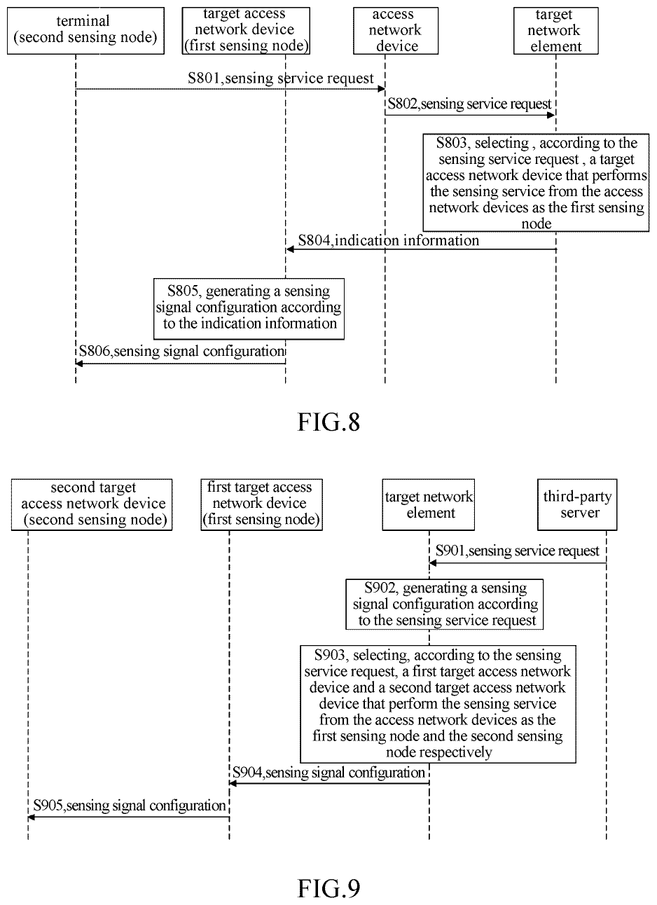

FIG. 8 shows a flowchart of a signal sensing method in another application scenario of sensing mode B in an exemplary embodiment. In this application scenario, sensing is performed between a terminal and an access network device, and the terminal transmits sensing signals, and the access network device receives the sensing signals transmitted by the terminal to achieve sensing. The terminal is used to initiate a sensing service request to the network, and the access network device and the target network element in the core network serve as the request processing end, which is used to receive the sensing service request, generate a sensing signal configuration according to the sensing service request, and send the sensing signal configuration to the aforementioned terminal.

Furthermore, referring to FIG. 8, the specific process of the signal sensing method is as follows.

S801, the terminal sends a sensing service request to the access network device.

S802, the access network device sends the sensing service request to the target network element in the core network.

S803, the target network element selects, according to the sensing service request, a target access network device that performs the sensing service from the access network devices as the first sensing node.

Exemplarily, if the sensing service request carries a sensing mode, the target network element selects, according to the sensing mode in the sensing service request, a target access network device that performs the sensing service from the access network devices as the first sensing node, and also determines the terminal that sends the sensing service request as the second sensing node.

For example, in this application scenario, a target access network device is selected, according to the sensing mode, from the access network devices that can provide the service of receiving sensing signals. Specifically, the selection can also be combined with the relevant policy information stored in the network. The target access network device may or may not be the same as the access network device in the previous step S802.

S804, the target network element sends indication information to the target access network device which serves as the first sensing node.

Exemplarily, if the sensing service request carries a security required indication, the target network element generates indication information according to the security required indication in the sensing service request and sends the indication information to the target access network device which serves as the first sensing node to instruct the target access network device to generate a sensing signal configuration according to the security required indication in the indication information.

S805, the target access network device as the first sensing node generates a sensing signal configuration according to the indication information.

Exemplarily, the target access network device generates a sensing signal configuration according to the security required indication in the indication information from the target network element. The specific process of generating the sensing signal configuration refers to the previous description and will not be repeated here.

S806, the target access network device as the first sensing node sends the sensing signal configuration to the terminal which serves as the second sensing node.

Through the above process, both the terminal and the target access network device that perform the sensing service obtain the same sensing signal configuration, so that sensing can be achieved between the terminal and the target access network device. Other nodes cannot obtain the sensing signal configuration, so they cannot correctly receive and process the sensing signals, and thus cannot obtain the sensing information therein.

In the above example, the target access network device serves as the first sensing node, and the terminal serves as the second sensing node. At the same time, the terminal also serves as the request initiating end, and the target access network device and the target network element in the core network serve as the request processing end.

Furthermore, the process of the signal sensing method in the application scenario of sensing mode C is basically the same as that of sensing mode B. Specifically, it can refer to FIGS. 7 and 8, and will not be repeated here.

It is worth noting that in the application scenario of sensing mode C, the target network element selects, according to the sensing mode in the sensing service request, a target access network device from the access network devices that can provide the service of transmitting sensing signals.

FIG. 9 shows a flowchart of a signal sensing method in an application scenario of sensing mode D in an exemplary embodiment. In this application scenario, sensing is performed between access network devices. In some embodiments, the sensing between access network devices includes self-sensing performed by an access network device on its own, meaning that the access network device both transmits sensing signals and receives the sensing signals it has transmitted to achieve sensing. In other embodiments, the sensing between access network devices includes sensing between different access network devices, that is, one access network device transmits sensing signals and another access network device receives sensing signals to achieve sensing.

Furthermore, referring to FIG. 9, the specific process of the signal sensing method is as follows.

S901, a third-party server sends a sensing service request to the target network element in the core network.

Here, the third-party server represents a third-party device that is not a sensing node. For example, the third-party server can be a server inside the core network.

S902, the target network element generates a sensing signal configuration according to the sensing service request.

Exemplarily, if the sensing service request carries a security required indication, the target network element generates a sensing signal configuration according to the security required indication in the sensing service request. The specific process of generating the sensing signal configuration refers to the previous description and will not be repeated here.

S903, the target network element selects, according to the sensing service request, a first target access network device and a second target access network device that perform the sensing service from the access network devices as the first sensing node and the second sensing node respectively.

S904, the target network element sends the sensing signal configuration to the first target access network device which serves as the first sensing node.

S905, the first target access network device as the first sensing node sends the sensing signal configuration to the second target access network device which serves as the second sensing node.

Through the above process, both the first target access network device and the second target access network device that perform the sensing service obtain the same sensing signal configuration, so that sensing can be achieved between the first target access network device and the second target access network device. Other nodes cannot obtain the sensing signal configuration, so they cannot correctly receive and process the sensing signals, and thus cannot obtain the sensing information therein.

In the above example, the first target access network device and the second target access network device serve as the first sensing node and the second sensing node respectively, the third-party server serves as the request initiating end, and the target network element in the core network serves as the request processing end.

In some embodiments, the target network element can also send the sensing signal configuration to the first target access network device which serves as the first sensing node and the second target access network device which serves as the second sensing node respectively.

In addition, in some embodiments, after selecting the first target access network device and the second target access network device that perform the sensing service, the target network element can send, according to the sensing service request, indication information to the first target access network device which serves as the first sensing node, to instruct the first target access network device to generate the sensing signal configuration by itself and to instruct the first target access network device to send the generated sensing signal configuration to the second target access network device which serves as the second sensing node. Thus, the target network element only needs to generate indication information instead of generating the sensing signal configuration.

The specific process of generating the sensing signal configuration refers to the previous description and will not be repeated here.

In such embodiments, the first target access network device and the target network element in the core network serve as the request processing end.

It can be understood that in some embodiments, the first target access network device and the second target access network device may be the same access network device. In this case, after the first target access network device as the first sensing node obtains the sensing signal configuration, it does not send the sensing signal configuration to other access network devices.

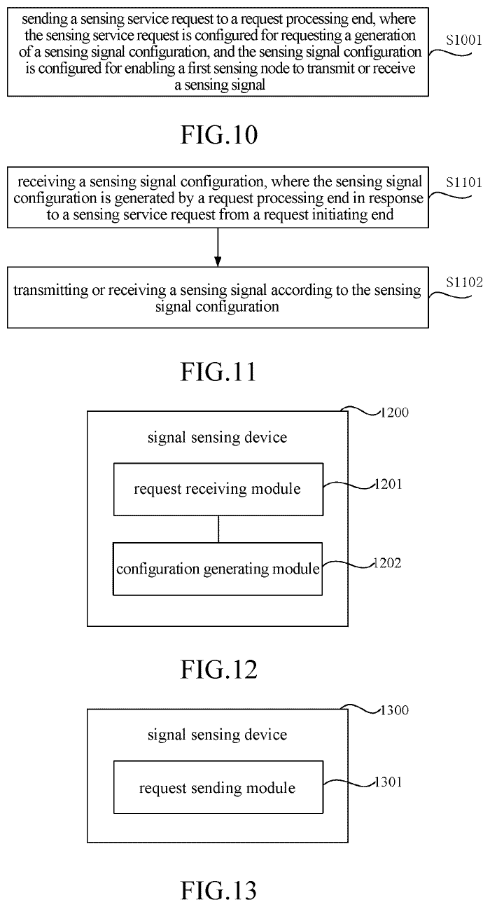

FIG. 10 shows a flowchart of a signal sensing method in an exemplary embodiment. The signal sensing method is applied to a request initiating end. As shown in FIG. 10, the signal sensing method includes the following steps.

S1001, sending a sensing service request to a request processing end. The sensing service request is configured for requesting generation of a sensing signal configuration, and the sensing signal configuration is configured for enabling a first sensing node to transmit or receive a sensing signal.

In the above process, by initiating a sensing service request to the request processing end and requesting the request processing end to generate a sensing signal configuration, the first sensing node is enabled to transmit or receive a sensing signal based on this sensing signal configuration. In this way, other nodes cannot correctly receive and process the sensing signals because they cannot obtain the sensing signal configuration, and thus cannot obtain the sensing information therein. This realizes the security protection of the sensing information.

In an exemplary embodiment, the request initiating end is a terminal. If the sensing service request carries a sensing mode indicating sensing between terminals, the signal sensing method further includes: receiving, by the terminal as the first sensing node, the sensing signal configuration.

For example, in the embodiments of FIGS. 5 and 6, the first terminal as the first sensing node receives the sensing signal configuration sent by the second terminal or the access network device.

In an exemplary embodiment, the signal sensing method further includes: sending, by the terminal, the sensing signal configuration to the second sensing node.

For example, in the embodiment of FIG. 6, the first terminal as the first sensing node receives the sensing signal configuration sent by the access network device and sends the sensing signal configuration to the second terminal which serves as the second sensing node.

In an exemplary embodiment, the request initiating end is a terminal. If the sensing service request carries a sensing mode indicating sensing between a terminal and an access network device, the signal sensing method further includes: receiving, by the terminal as the second sensing node, the sensing signal configuration sent by the first sensing node.

For example, in the embodiments of FIGS. 7 and 8, the terminal as the second sensing node receives the sensing signal configuration sent by the target access network device which serves as the first sensing node.

In an optional embodiment, the sensing service request carries a security required indication, and the security required indication is configured for indicating a requirement for providing a security guarantee mechanism. The sensing signal configuration is generated according to the security required indication. The sensing signal configuration includes first configuration information and second configuration information for the sensing signal. The first configuration information includes initial configuration information for a plurality of signal parameters of the sensing signal, and the second configuration information includes change indication information indicating a dynamic change for at least one of the plurality of signal parameters.

In an optional embodiment, the sensing service request carries a security required indication, and the security required indication is configured for indicating that no security guarantee mechanism is required to be provided. The sensing signal configuration is generated according to the security required indication. The sensing signal configuration includes first configuration information for the sensing signal, and the first configuration information includes configuration information for a plurality of signal parameters of the sensing signal.

As an example, the plurality of signal parameters of the above-mentioned sensing signal can include at least one of the following: initial time, a period, and a frequency domain for transmitting the sensing signal.

FIG. 11 shows a flowchart of a signal sensing method in an exemplary embodiment. The signal sensing method is applied to a sensing node. As shown in FIG. 11, the signal sensing method includes the following steps.

S1101, receiving a sensing signal configuration. The sensing signal configuration is generated by a request processing end in response to a sensing service request from a request initiating end.

S1102, transmitting or receiving a sensing signal according to the sensing signal configuration.

In this technical solution, the request processing end generates a sensing signal configuration in response to the sensing service request from the request initiating end. The sensing node receives the sensing signal configuration and transmits or receives sensing signals based on this sensing signal configuration. In this way, other nodes cannot correctly receive and process the sensing signals because they cannot obtain the sensing signal configuration, and thus cannot obtain the sensing information therein. This realizes the security protection of the sensing information.

In an optional embodiment, the sensing signal configuration includes first configuration information and second configuration information for the sensing signal. The first configuration information includes initial configuration information for a plurality of signal parameters of the sensing signal, and the second configuration information includes change indication information indicating a dynamic change for at least one of the plurality of signal parameters.

In an optional embodiment, the sensing signal configuration includes first configuration information for the sensing signal, and the first configuration information includes configuration information for a plurality of signal parameters of the sensing signal.

As an example, the plurality of signal parameters of the above-mentioned sensing signal can include at least one of the following: initial time, a period, and a frequency domain for transmitting the sensing signal.

It should be noted that the sensing node in this embodiment can execute all of the steps of the first sensing node and/or the second sensing node in the previous embodiments. That is, in some application scenarios, the sensing node can serve as the first sensing node and execute the steps of the first sensing node. In other application scenarios, the sensing node can also serve as the second sensing node and execute the steps of the second sensing node.

The signal sensing method of the sensing node in this embodiment refers to the previous method embodiments and will not be repeated here.

FIG. 12 shows a block diagram of a signal sensing device in an exemplary embodiment. The signal sensing device is configured at a request processing end. As shown in FIG. 12, the signal sensing device 1200 includes:
a request receiving module 1201 configured to receive a sensing service request; and
a configuration generating module 1202 configured to generate a sensing signal configuration according to the sensing service request. The sensing signal configuration is configured for enabling a first sensing node to transmit or receive a sensing signal.

In some embodiments, the sensing service request carries a security required indication, and the security required indication is configured for indicating a requirement for providing a security guarantee mechanism, the configuration generating module 1202 is configured to generate the sensing signal configuration according to the security required indication. The sensing signal configuration includes first configuration information and second configuration information for the sensing signal. The first configuration information includes initial configuration information for a plurality of signal parameters of the sensing signal, and the second configuration information includes change indication information indicating a dynamic change for at least one of the plurality of signal parameters.

In some embodiments, the sensing service request carries a security required indication, and the security required indication is configured for indicating that no security guarantee mechanism is required to be provided, the configuration generating module 1202 is configured to generate the sensing signal configuration according to the security required indication. The sensing signal configuration includes first configuration information for the sensing signal, and the first configuration information includes configuration information for a plurality of signal parameters of the sensing signal.

In some embodiments, the plurality of signal parameters for the sensing signal include: initial time, a period, and a frequency domain for transmitting the sensing signal.

In some embodiments, the sensing service request carries a sensing mode, and the request processing end includes a target network element in the core network. The signal sensing device 1200 includes: a node determining module configured in the target network element and configured to determine the first sensing node according to the sensing mode.

In some embodiments, the node determining module is configured to, when the sensing mode indicates sensing between terminals, determine the terminal that sends the sensing service request as the first sensing node.

In some embodiments, the node determining module is configured to, when the sensing mode indicates sensing between a terminal and an access network device, determine the first sensing node that performs sensing service from access network devices.

In some embodiments, the node determining module is configured to, when the sensing mode indicates sensing between access network devices, determine the first sensing node and a second sensing node that perform sensing service from the access network devices.

In some embodiments, the request processing end further includes the first sensing node. The configuration generating module 1202 includes: an indication generating sub-module configured in the target network element and configured to send indication information to the first sensing node according to the sensing service request; and a configuration generating sub-module configured in the first sensing node and configured to generate the sensing signal configuration according to the indication information.

In some embodiments, the request processing end includes a second sensing node in device-to-device communication with the first sensing node. The request receiving module 1201 and the configuration generating module 1202 are both configured in the second sensing node. The request receiving module 1201 is configured to receive the sensing service request sent by the first sensing node, and the configuration generating module 1202 is configured to generate the sensing signal configuration according to the sensing service request and send the sensing signal configuration to the first sensing node.

It should be noted that the request processing end can be any one of the following: a terminal;
a target network element in the core network; or
an access network device and a target network element in the core network.

Specifically, detailed descriptions have been provided above for sensing modes A-D, and will not be repeated here.

FIG. 13 shows a block diagram of a signal sensing device in an exemplary embodiment. The signal sensing device is configured at a request initiating end. As shown in FIG. 13, the signal sensing device 1300 includes:

a request sending module 1301 configured to send a sensing service request to a request processing end. The sensing service request is configured for requesting generation of a sensing signal configuration, and the sensing signal configuration is configured for enabling a first sensing node to transmit or receive a sensing signal.

In some embodiments, when the request initiating end is a terminal and the sensing service request carries a sensing mode indicating sensing between terminals, the signal sensing device 1300 includes: a first configuration receiving module configured in the terminal as the first sensing node and configured to receive the sensing signal configuration.

In some embodiments, the signal sensing device 1300 includes: a second configuration receiving module configured to send the sensing signal configuration to the second sensing node.

In some embodiments, when the request initiating end is a terminal and the sensing service request carries a sensing mode indicating sensing between a terminal and an access network device, the signal sensing device 1300 includes: a third configuration receiving module configured in the terminal as the second sensing node and configured to receive the sensing signal configuration sent by the first sensing node.

In some embodiments, the sensing service request carries a security required indication, and the security required indication is configured for indicating a requirement for providing a security guarantee mechanism. The sensing signal configuration is generated according to the security required indication. The sensing signal configuration includes first configuration information and second configuration information for the sensing signal. The first configuration information includes initial configuration information for a plurality of signal parameters of the sensing signal, and the second configuration information includes change indication information indicating a dynamic change for at least one of the plurality of signal parameters.

In some embodiments, the sensing service request carries a security required indication, and the security required indication is configured for indicating that no security guarantee mechanism is required to be provided. The sensing signal configuration is generated according to the security required indication. The sensing signal configuration includes first configuration information of the sensing signal, and the first configuration information includes configuration information for a plurality of signal parameters of the sensing signal.

In some embodiments, the plurality of signal parameters of the sensing signal include: initial time, a period, and a frequency domain for transmitting the sensing signal.

It should be noted that the request initiating end can be any one of the following: a terminal; or a third-party server.

Specifically, detailed descriptions have been provided above for sensing modes A-D, and will not be repeated here.

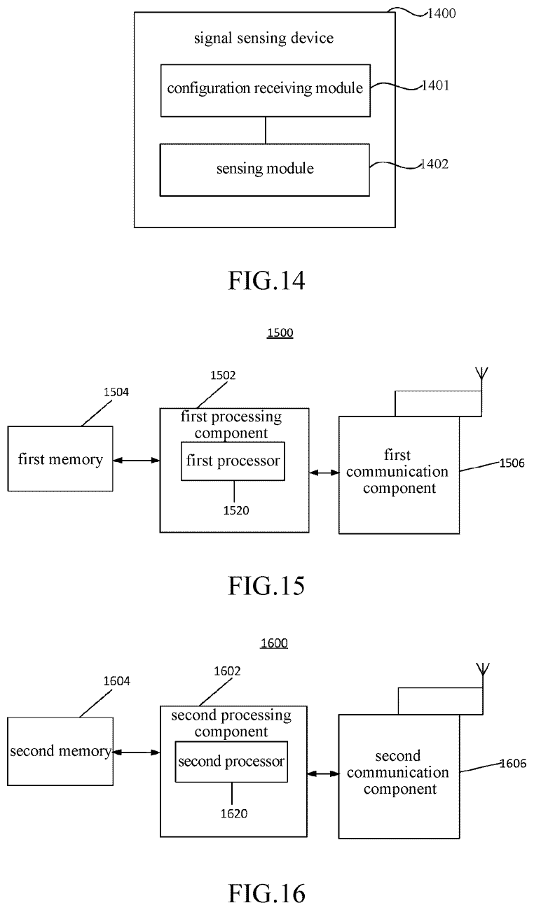

FIG. 14 shows a block diagram of a signal sensing device in an exemplary embodiment. The signal sensing device is configured at a sensing node. As shown in FIG. 14, the signal sensing device 1400 includes:

a configuration receiving module 1401 configured to receive a sensing signal configuration, where the sensing signal configuration is generated by a request processing end in response to a sensing service request from a request initiating end; and a sensing module 1402 configured to transmit or receive a sensing signal according to the sensing signal configuration.

In some embodiments, the sensing signal configuration includes first configuration information and second configuration information for the sensing signal. The first configuration information includes initial configuration information for a plurality of signal parameters of the sensing signal, and the second configuration information includes change indication information indicating a dynamic change for at least one of the plurality of signal parameters.

In some embodiments, the sensing signal configuration includes first configuration information for the sensing signal, and the first configuration information includes configuration information for a plurality of signal parameters of the sensing signal.

It should be noted that the sensing node can be any one of the following:
a terminal; or
an access network device.

Regarding the devices in the above-mentioned embodiments, the specific ways in which each module executes operations have been described in detail in the embodiments related to the method, and will not be elaborated here.

FIG. 15 shows a block diagram of a core network element in an exemplary embodiment. The core network element is the target network element in the previous embodiments. Referring to FIG. 15, the core network element 1500 can include one or more of the following components: a first processing component 1502, a first memory 1504, and a first communication component 1506.

The first processing component 1502 can be configured to control the overall operation of the core network element 1500. The first processing component 1502 can include one or more first processors 1520 to execute instructions to complete all or part of the steps of the target network element which serves as the request processing end in the above-mentioned signal sensing method. In addition, the first processing component 1502 can include one or more modules to facilitate the interaction between the first processing component 1502 and other components. For example, the first processing component 1502 can include an input/output interface module to facilitate the interaction between the input/output interface component and the first processing component 1502.

The first memory 1504 is configured to store various types of data to support the operation of the core network element 1500. Examples of these data include instructions for any application or method operating on the core network element 1500. The first memory 1504 can be implemented by any type of volatile or non-volatile storage device or a combination thereof, such as static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disc.

The first communication component 1506 is configured to facilitate wired or wireless communication between the core network element 1500 and other devices. The core network element 1500 can access a wireless network based on communication standards, such as Wi-Fi, 2G, 3G, 4G, 5G, 6G, NB-IOT, eMTC, etc., or a combination thereof.

FIG. 16 shows a block diagram of an electronic device in an exemplary embodiment. The electronic device is the request initiating end in the previous embodiments. For example, the electronic device may be a terminal or a third-party server. Referring to FIG. 16, the electronic device 1600 can include one or more of the following components: a second processing component 1602, a second memory 1604, and a second communication component 1606.

The second processing component 1602 can be configured to control the overall operation of the electronic device 1600. The second processing component 1602 can include one or more second processors 1620 to execute instructions to complete all or part of the steps of the request initiating end in the above-mentioned signal sensing method. In addition, the second processing component 1602 can include one or more modules to facilitate the interaction between the second processing component 1602 and other components. For example, the second processing component 1602 can include an input/output interface module to facilitate the interaction between the input/output interface component and the second processing component 1602.

The second memory 1604 is configured to store various types of data to support the operation of the electronic device 1600. Examples of these data include instructions for any application or method operating on the electronic device 1600. The second memory 1604 can be implemented by any type of volatile or non-volatile storage device or a combination thereof, such as static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disc.

The second communication component 1606 is configured to facilitate wired or wireless communication between the electronic device 1600 and other devices. The electronic device 1600 can access a wireless network based on communication standards, such as Wi-Fi, 2G, 3G, 4G, 5G, 6G, NB-IOT, eMTC, etc., or a combination thereof. In an exemplary embodiment, the second communication component 1606 receives broadcast signals or broadcast-related information from an external broadcast management system via a broadcast channel.

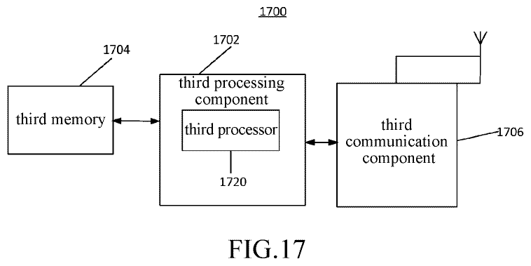

FIG. 17 shows a block diagram of an electronic device in an exemplary embodiment. The electronic device is the sensing node in the previous embodiments. For example, the electronic device may be a terminal or an access network device. Referring to FIG. 17, the electronic device 1700 can include one or more of the following components: a third processing component 1702, a third memory 1704, and a third communication component 1706.

The third processing component 1702 can be configured to control the overall operation of the electronic device 1700. The third processing component 1702 can include one or more third processors 1720 to execute instructions to complete all or part of the steps of the sensing node in the above-mentioned signal sensing method. In addition, the third processing component 1702 can include one or more modules to facilitate the interaction between the third processing component 1702 and other components. For example, the third processing component 1702 can include an input/output interface module to facilitate the interaction between the input/output interface component and the third processing component 1702.

The third memory 1704 is configured to store various types of data to support the operation of the electronic device 1700. Examples of these data include instructions for any application or method operating on the electronic device 1700. The third memory 1704 can be implemented by any type of volatile or non-volatile storage device or a combination thereof, such as static random-access memory (SRAM), electrically erasable programmable read-only memory (EEPROM), erasable programmable read-only memory (EPROM), programmable read-only memory (PROM), read-only memory (ROM), magnetic memory, flash memory, magnetic disk, or optical disc.

The third communication component 1706 is configured to facilitate wired or wireless communication between the electronic device 1700 and other devices. The electronic device 1700 can access a wireless network based on communication standards, such as Wi-Fi, 2G, 3G, 4G, 5G, 6G, NB-IOT, eMTC, etc., or a combination thereof. In an exemplary embodiment, the third communication component 1706 receives broadcast signals or broadcast-related information from an external broadcast management system via a broadcast channel.

In an exemplary embodiment, the present disclosure also provides a computer-readable storage medium on which a computer program is stored. When the computer program is executed by a processor, all or part of the steps of the target network element in the signal sensing method provided by the present disclosure are implemented.

In an exemplary embodiment, the present disclosure also provides a computer-readable storage medium on which a computer program is stored. When the computer program is executed by a processor, all or part of the steps of the request initiating end in the signal sensing method provided by the present disclosure are implemented.

In an exemplary embodiment, the present disclosure also provides a computer-readable storage medium on which a computer program is stored. When the computer program is executed by a processor, all or part of the steps of the sensing node in the signal sensing method provided by the present disclosure are implemented.

In another exemplary embodiment, a computer program product is also provided. The computer program product contains a computer program that can be executed by a programmable device. The computer program has a code portion for performing the above-mentioned signal sensing method when executed by the programmable device.

Those skilled in the art, after considering the specification and practicing the present disclosure, will readily conceive of other embodiments of the present disclosure. This application is intended to cover any variations, uses, or adaptations of the present disclosure. These variations, uses, or adaptations follow the general principles of the present disclosure and include common knowledge or conventional technical means in the field of the present disclosure that are not disclosed in the present disclosure. The specification and embodiments are only regarded as exemplary, and the true scope and spirit of the present disclosure are pointed out by the following claims.

It should be understood that the present disclosure is not limited to the precise structures described above and shown in the drawings, and various modifications and changes can be made without departing from its scope. The scope of the present disclosure is only limited by the appended claims.

1. A signal sensing method, performed by a request processing end, the method comprising:
receiving a sensing service request; and
generating a sensing signal configuration according to the sensing service request, wherein the sensing signal configuration is configured for enabling a first sensing node to transmit or receive a sensing signal.

2. The method according to claim 1, wherein the sensing service request carries a security required indication, and the security required indication is configured for indicating a requirement for providing a security guarantee mechanism; and
the generating the sensing signal configuration according to the sensing service request comprises:
generating the sensing signal configuration according to the security required indication, wherein the sensing signal configuration comprises first configuration information and second configuration information for the sensing signal, the first configuration information comprises initial configuration information for a plurality of signal parameters of the sensing signal, and the second configuration information comprises change indication information indicating a dynamic change for at least one of the plurality of signal parameters.

3. The method according to claim 1, wherein the sensing service request carries a security required indication, and the security required indication is configured for indicating that no security guarantee mechanism is required;
the generating the sensing signal configuration according to the sensing service request comprises:
generating the sensing signal configuration according to the security required indication, wherein the sensing signal configuration comprises first configuration information for the sensing signal, and the first configuration information comprises configuration information for a plurality of signal parameters of the sensing signal.

4. The method according to claim 2, wherein the plurality of signal parameters for the sensing signal comprise: initial time, a period, and a frequency domain for transmitting the sensing signal.

5. The method according to claim 1, wherein the sensing service request carries a sensing mode, the request processing end comprises a target network element in a core network, and the method further comprises:
determining, by the target network element, the first sensing node according to the sensing mode.

6. The method according to claim 5, wherein the determining the first sensing node according to the sensing mode comprises:
in response to determining that the sensing mode indicates sensing between terminals, determining a terminal that sends the sensing service request as the first sensing node.

7. The method according to claim 5, wherein the determining the first sensing node according to the sensing mode comprises:
in response to determining that the sensing mode indicates sensing between a terminal and an access network device, determining the first sensing node that performs sensing service from access network devices.

8. The method according to claim 5, wherein the determining the first sensing node according to the sensing mode comprises:
in response to determining that the sensing mode indicates sensing between access network devices, determining the first sensing node and a second sensing node that perform sensing service from the access network devices.

9. The method according to claim 5, wherein the request processing end further comprises the first sensing node, and the generating the sensing signal configuration according to the sensing service request comprises:
sending, by the target network element, indication information to the first sensing node according to the sensing service request; and
generating, by the first sensing node, the sensing signal configuration according to the indication information.

10. The method according to claim 1, wherein the request processing end comprises a second sensing node in device-to-device communication with the first sensing node, and the receiving the sensing service request comprises:
receiving, by the second sensing node, the sensing service request sent by the first sensing node; and
wherein the generating the sensing signal configuration according to the sensing service request comprises:
generating, by the second sensing node, the sensing signal configuration according to the sensing service request and sending the sensing signal configuration to the first sensing node.

11. The method according to claim 1, wherein the request processing end is any one of:
a terminal;
a target network element in a core network; or
a combination of an access network device and a target network element in a core network.

12. A signal sensing method, performed by a request initiating end, the method comprising:
sending a sensing service request to a request processing end, wherein the sensing service request is configured for requesting generation of a sensing signal configuration, and the sensing signal configuration is configured for enabling a first sensing node to transmit or receive a sensing signal.

13. The method according to claim 12, wherein the request initiating end is a terminal, the sensing service request carries a sensing mode indicating sensing between terminals, and the method further comprises:
receiving, by the terminal as the first sensing node, the sensing signal configuration.

14. The method according to claim 13, further comprising:
sending the sensing signal configuration to a second sensing node.

15. The method according to claim 12, wherein the request initiating end is a terminal, the sensing service request carries a sensing mode indicating sensing between a terminal and an access network device, and the method further comprises:
receiving, by the terminal as a second sensing node, the sensing signal configuration sent by the first sensing node.

16.-18. (canceled)

19. The method according to claim 12, wherein the request initiating end is any one of:
a terminal; or
a third-party server.

20. A signal sensing method, performed by a sensing node, the method comprising:
receiving a sensing signal configuration, wherein the sensing signal configuration is generated by a request processing end in response to a sensing service request from a request initiating end; and
transmitting or receiving a sensing signal according to the sensing signal configuration.

21. (canceled)

22. (canceled)

23. The method according to any claim 20, wherein the sensing node is any one of:
a terminal; or
an access network device.

24.-26. (canceled)

27. A core network element, comprising:
a first processor; and
a first memory for storing instructions executable by the first processor;
wherein, when the first processor executes the instructions, the first processor serves as a request processing end to execute the method according to claim 1.

28. (canceled)

29. (canceled)

30. A non-transitory storage medium storing a computer program that, when executed by a processor, causes the processor to perform the method according to claim 1.

31.-33. (canceled)
